(19) United States
(12) Patent Application Publication
(10) Pub. No.: US 2009/0172791 A1
(43) Pub. Date: Jul. 2, 2009

(54) USER ACCESS METHOD AND SYSTEM

(75) Inventors: Yinggang Du, Shenzhen (CN); Wei Ruan, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/399,458

(22) Filed: Mar. 6, 2009

Related U.S. Application Data
(63) Continuation of application No. PCT/CN2007/070653, filed on Sep. 7, 2007.

(30) Foreign Application Priority Data
Sep. 7, 2006 (CN) 200610126200.7

(51) Int. Cl. G06F 21/20; H04K 1/04

(52) U.S. Cl. 726/5; 380/287

(57) ABSTRACT

A user access method and system are provided. The method includes the following steps. After the connection between a terminal and an access network AN is disconnected, a media access control identifier MAC ID is preserved in a predetermined time period. If the terminal initiates an access to the AN within the predetermined time period, the MAC ID is used by the terminal for accessing the AN. The system of the present embodiment includes a terminal and an AN. According to the method and system, the access time initiated by the terminal is reduced, the access collision is avoided, and the system performance is greatly enhanced.

### CROSS-REFERENCE TO RELATED APPLICATIONS

This application is a continuation in part of International Application No. PCT/CN2007/070653, filed on Sep. 7, 2007, which claims the priority of CN application No. 200610126200.7, filed on Sep. 7, 2006, titled “user access method and system”, the entire contents of all of which are incorporated herein by reference.

### FIELD OF THE INVENTION

The present invention relates to a communication technology, and more particularly to a user access method and system.

### BACKGROUND OF THE INVENTION

The progress in the mobile communication system promotes the rapid development of the information industry, and brings great changes to our daily life.

A mobile communication system includes a certain number of base stations (BSs). Each BS is in concurrent communication with a plurality of terminals. The terminals are randomly distributed in the BS coverage of the whole mobile communication system. When a terminal intends to communicate with the BS, a random access is initiated. Therefore, the random access technique is critical in the access of various wireless communication multiple access systems.

A random access channel is generally composed of two parts, namely, a prefix and a message. The prefix is adapted to realize uplink synchronization and carry a random ID as well as other information. The message usually carries information such as a connection request.

When a terminal intends to make a conversation or use a service of the network, the terminal transits from an Idle state to an Active state and initiates a random access request. The process of the random access request is as shown in FIG. 1, which is a flow chart of a random access in the 3 Generation Partnership Project II (3GPP2).

In Step S101, the terminal first sends an access prefix to an access network (AN). The access prefix contains an access prefix sequence that is also referred to as a signature sequence. Receiving no acknowledge information from the AN within a certain period of time, the terminal retreats for a while, i.e., resends the prefix after waiting for a while.

In Step S102, the AN captures the access prefix sequence sent by the terminal, and sends an acknowledge information via a forward common control channel (F-CCCH). The acknowledge information contains a medium access control identifier (MAC ID) allocated by the AN to the terminal, an access prefix sequence index, a reverse resource allocation information, and timing information.

In Step S103, the terminal receives the acknowledge information, and adjusts the sending timing to realize a reverse synchronization with the AN. Further, the terminal scrambles its own unicast access terminal identifier (UATI) by using the obtained MAC ID on a reverse data channel to generate a bind request, and sends the bind request to the AN.

In Step S104, on receiving the bind request, the AN descrambles and detects the request by using the allocated MAC ID to obtain the UATI, then generates a bind response after scrambling the UATI with the MAC ID, and sends the bind response to the terminal.

In Step S105, the terminal determines whether the bind response is received within a predetermined time period (generally, 100 ms).

If the bind response is not received within a predetermined time period, the access is considered a failure, and the flow goes back to Step S101; otherwise, Step S106 is performed.

In Step S106, the terminal descrambles the bind response from the receiving end by using the MAC ID, and detects whether the UATI obtained after descrambling is the UATI of its own.

If the UATI obtained after descrambling is the UATI of its own, the access is successful, and the AN sends a service channel allocation message to the terminal via a forward data channel so as to establish a link between the terminal and the AN. Otherwise, it indicates that the terminal collides with other users and the access fails, so that a re-access is needed, and the flow goes back to Step S101.

The circumstances for a terminal that drops a call and a terminal that requires frequent access are described below. For the terminal that drops a call, no matter being a calling or called party, the terminal has to perform random access every time. Especially when the terminal that drops the call is a calling party, the re-access is performed immediately after the call drop. Thereby, such terminal is regarded as a terminal in need of frequent access. When the frequent access is performed in the above manner, the network needs to re-allocate the MAC ID each time, so that the access time is long, the collision of the access prefix easily occurs, and the access power consumption is too much.

### SUMMARY OF THE INVENTION

The present embodiment provides a user access method. The method includes the following steps.

After the connection between a terminal and an access network (AN) is disconnected, a media access control identifier (MAC ID) is preserved in a predetermined time period. If the terminal initiates an access to the AN within the predetermined time period, the MAC ID is used by the terminal for accessing the AN.

The present embodiment further provides a user access system including a terminal and an access network (AN).

The terminal is adapted to preserve an MAC ID in a predetermined time period after the connection with the AN is disconnected. If the terminal initiates an access to the AN within the predetermined time period, the MAC ID is used by the terminal for accessing the AN.

The AN is adapted to preserve the MAC ID after the terminal is disconnected.

The present embodiment further provides a terminal.

The terminal is adapted to preserve an MAC ID in a predetermined time period after the connection with an access network (AN) is disconnected. If the terminal initiates an access to the AN within the predetermined time period, the MAC ID is used by the terminal for accessing the AN.

### BRIEF DESCRIPTION OF THE DRAWINGS

The present invention will become better understood from the detailed description given herein below for illustration only, and thus are not limitative to the present invention.

FIG. 1 is a flow chart of a random access in 3GPP2;

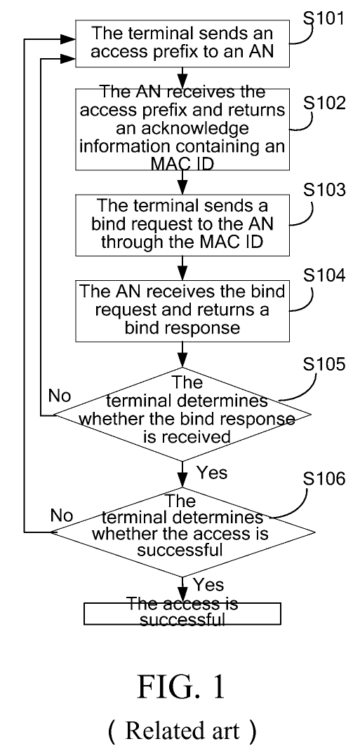

FIG. 2 is a flow chart of a user access method according to an embodiment of the present invention;

FIG. 3 is a flow chart of a method for a user access system according to a first embodiment of the present invention;

FIG. 4 is a flow chart of a method for a user access system according to a second embodiment of the present invention;

FIG. 5 is a flow chart of a method for a user access system according to a third embodiment of the present invention; and

FIG. 6 is a schematic view of a system according to an embodiment of the present invention.

### DETAILED DESCRIPTION OF THE EMBODIMENTS

In a mobile communication system, when a terminal intends to make a conversation or use a service of the network, the terminal transits from an Idle state to an Active state and initiates a random access request to the AN. During the conversation or service, if the call is dropped or the service is interrupted or ends, the terminal needs to re-initiate an access, and the AN re-allocates a MAC ID to the terminal during the access.

In order to prevent the terminal from performing the whole random access process during the re-access, in a method of the present embodiment, when the terminal drops a call or ends the current service, the terminal continues to maintain the MAC ID for a period of time, and the state within this period of time is called a Hold state. If the terminal intends to re-access in the Hold state, the preserved MAC ID is employed to re-initiate an access to the AN.

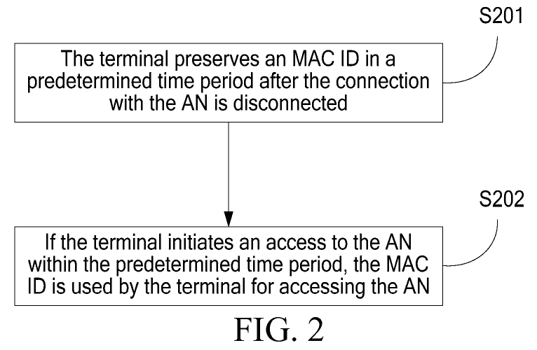

FIG. 2 is a flow chart of a user access method according to an embodiment of the present invention. The method includes the following steps.

In Step S201, the terminal preserves an MAC ID for a predetermined time after the connection with the AN is disconnected.

In Step S202, if the terminal initiates an access to the AN within the predetermined time, the MAC ID is used by the terminal for accessing the AN.

### Embodiment 1

When the terminal intends to re-initiate an access, the terminal directly scrambles a sequence selected from random access prefix sequences with the preserved MAC ID and sends the sequence to the AN. The AN descrambles the received sequence with the MAC ID in the Hold state, and further detects the descrambled sequence. As the MAC ID is allocated to only one terminal within a cell, the random access prefix is scrambled by the MAC ID. Even if other terminals adopt the same random access prefix, no collision will occur. Besides, as the MAC ID is already allocated, there is no need to re-designate an MAC ID by the AN, so that an access acknowledgement can be directly performed. Thereby, the access time of the terminal is further shortened, and the power consumption for terminal access is reduced.

In order to further reduce the power consumption of the detection of the AN, the MAC ID is corresponding to the access prefix, i.e., an MAC ID is corresponding to one or more access prefixes. Then, the MAC ID is adopted to scramble the prefix, so that the processing of the AN on the MAC ID in the Hold state is more efficient, and the access is accelerated. Here, a plurality of access prefixes is provided as the access prefixes can be arranged into several groups according to the strength of the downlink pilot and the priority of the services. For example, nine groups are arranged in 802.20, as shown in Table 1.

TABLE 1

| Pilot | Request | | |
|---|---|---|---|
| strength | priority | | |
| level | 1 | 2 | 3 |
| 1 | 1 | 2 | 3 |
| 2 | 4 | 5 | 6 |
| 3 | 7 | 8 | 9 |

The column of the table represents the strength level of the downlink pilot, and the row represents the request priority. Thus, on receiving a corresponding prefix sequence, the AN determines the distance of the terminal away from the BS, the service priority requested thereby, and other information.

Accordingly, each MAC ID is corresponding to one or more sequences in each of the nine groups. Thereby, the AN figures out information such as the distance of the terminal from the BS according to the received access prefix.

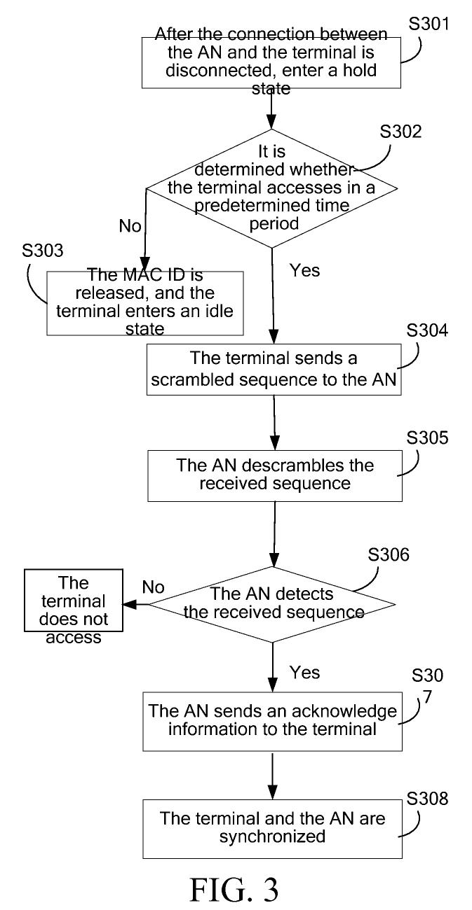

FIG. 3 is a flow chart of a method for a user access system according to this embodiment. The method includes the following steps.

In Step S301, after the connection between the AN and the terminal is disconnected, the AN and the terminal release physical resources other than the MAC ID, and enter a Hold state. Meanwhile, timers on the AN and the terminal start timing, and the MAC ID transits to a Hold set on the AN side.

In Step S302, it is determined whether the terminal initiates an access in a time range set by the timer, and if the terminal does not need to access within a predetermined time of the timer, Step S303 is performed; otherwise, Step S304 is performed.

In Step S303, the AN and the terminal release the MAC ID simultaneously, and the terminal enters an Idle state.

In Step S304, when accessing again, the terminal first selects a sequence randomly from the access prefix sequence set, then scrambles the access prefix sequence with the MAC ID or a scrambling code corresponding to the MAC ID, and sends the scrambled sequence to the AN.

The selecting mode of the access prefix sequence is not limited to the above. An MAC ID may also be corresponding to one or more access prefix sequences in each group, and the access prefix sequence is selected according to the terminal condition in the network. When the MAC ID is corresponding to only one access prefix sequence in each group, the desired sequence in a certain group is directly selected, and when the MAC ID is corresponding to multiple access prefix sequences in each group, a prefix sequence is selected randomly from the multiple sequences in a certain group.

In Step S305, on receiving the scrambled sequence, the AN side descrambles the received access prefix sequence with each MAC ID in a Hold state in the Hold set or a scrambling code corresponding to the MAC ID.

In Step S306, the AN detects the descrambled sequence to determine whether the terminal accesses, and if yes, Step S307 is performed.

According to the selecting mode of the prefix sequence, a corresponding detection method is provided as follows.

In the method of randomly selecting a sequence during the re-access, all the access prefix sequences are correlated with the received sequence. For example, it is assumed that the received sequence is: r_{—}0, r_{—}1, r_{—}2, . . . , r_{—}1023, and all the access prefix sequences are: s(i,0), s(i,1), . . . , s(i,1023), in which i=0, 1, . . . , 1023, i.e., altogether there are 1024 access prefix sequences with the length of 1024. When being correlated, each access prefix sequence is operated as follows to obtain a correlation value: C(i)=r_{—}0*s(i,0)+r_{—}1*s(i,1)+ . . . +r_{—}1023*s(i,1023). As r contains a complex channel gain, C(i) is generally a complex value, and the comparative value is p(i)=C(i)*C(i)′. A maximum value is selected from all the p(i) values, and the sequence corresponding to the obtained i is a target sequence.

It is determined whether a terminal access corresponding to the MAC ID occurs according to the comparison of a maximum value among all the correlation values of the access prefix sequences and the received sequence with a predetermined threshold. If the maximum correlation value exceeds the predetermined threshold, the terminal accesses; otherwise, the terminal does not access.

In the method of selecting a sequence from multiple access prefix sequences corresponding to the MAC ID for scrambling, the multiple access prefix sequences corresponding to the MAC ID are directly correlated with the received sequence. If the maximum value among the correlation values exceeds the predetermined threshold, the terminal accesses; otherwise, the terminal does not access.

In the method of selecting an access prefix sequence from each group corresponding to the MAC ID for scrambling, the access prefix sequence of each group corresponding to the MAC ID is directly correlated with the received sequence. If the correlation value exceeds the predetermined threshold, the terminal accesses; otherwise, the terminal does not access.

In the method of selecting a sequence from the prefix sequences corresponding to the MAC ID for scrambling, as each group includes one or more prefix sequences, it is easy to determine whether the received prefix sequence is a sequence corresponding to the MAC ID. In order to enhance the accuracy of determination, besides determining whether the maximum value exceeds the predetermined threshold, it is also determined whether the location of the maximum value falls in the prefix sequence corresponding to the MAC ID, and if yes, the access is determined as a terminal access corresponding to the MAC ID; otherwise, the terminal does not access.

In Step S307, the AN sends an acknowledge information to the terminal via an F-CCCH when it is determined that the terminal accesses. The acknowledge information contains the timing information allocated by the AN to the terminal, and other information.

In Step S308, the terminal receives the acknowledge information, and adjusts the send timing to realize a reverse synchronization with the AN.

Thereby, the access is completed.

The time T in which the MAC ID is in a Hold state depends on the load condition of the AN. For example, T is in a range of 0 to 60 s, and the MAC ID is not preserved at 0. The load condition should be considered as the terminal access in the Hold state needs to be detected, so that the system complexity and the access time are both increased. If the AN side has no resource to perform an access detection on the terminal in the Hold state, the time in the Hold state is short and even 0; otherwise, the time is long. As for the terminal, the preservation of the MAC ID does not increase any additional processing cost, and only 11 bits are added in the Idle state, i.e., the length of the MAC ID. Even if the MAC IDs corresponding to all the elements in the Active set are preserved, only 11×8 bits are added in the memory. The holding of the MAC ID equals to extend the current conversation time by T s. As operations such as data exchange are not required, related processing like charging is not affected. In the existing system, the load condition of the system needs to be broadcasted in a broadcast channel at a certain cycle, so the setting of T does not add any signaling cost.

If the terminal does not access after T s, the AN and the terminal both release the MAC ID, and the terminal truly transits to an Idle state.

When the aforementioned first embodiment is applied in a network, no matter how the terminal selects the access prefix sequence, the access prefix sequence not only serves the terminal that preserves the MAC ID after the connection with the network is disconnected. The access prefix sequence may also serve the terminal that does not preserve the MAC ID after the connection with the network is disconnected, and the terminal accesses in the manner mentioned in the prior art.

In the method of the present embodiment, the process that the terminal preserves the MAC ID in a predetermined time period for accessing is not limited to the above. The access prefix sequence may be classified into an access prefix sequence employed by the terminal that preserves the MAC ID after the connection with the network is disconnected and an access prefix sequence employed by the terminal that does not preserve the MAC ID after the connection with the network is disconnected. Therefore, during the access, the terminal that preserves the MAC ID employs the access prefix sequence corresponding to the terminal that preserves the MAC ID for accessing, and the AN does not allocate the MAC ID to the terminal.

### Embodiment 2

After the conversation ends, the conversation link is cancelled. The AN switches the MAC ID corresponding to the terminal from the Active set to the Hold set, and starts timing after informing the terminal about the duration of the Hold state according to the current load condition. The terminal transits from the Active state to the Hold state, starts timing according to the obtained duration of the Hold state, and continues preserving the MAC ID.

If the terminal intends to re-access during this period of time, the AN does not need to re-allocate the MAC ID to the terminal for accessing. Thereby, the access time and the power consumption during the access are both reduced. Moreover, as the descrambling performed by the AN on the MAC ID of the access sequence is avoided, the Hold state lasts for a longer time.

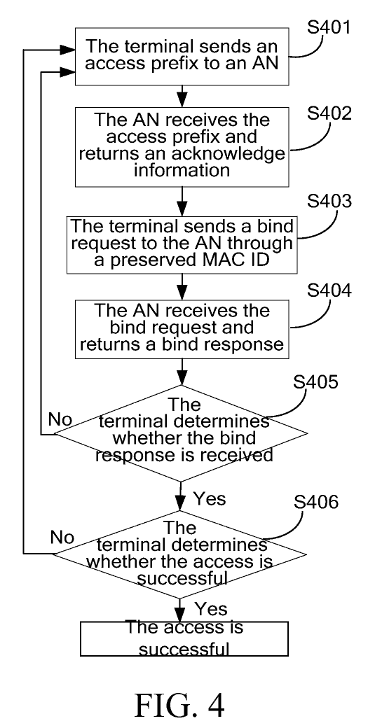

In the Hold state, the user re-initiates an access in the following manner, as shown in FIG. 4.

In Step S401, the terminal first sends an access prefix to an AN. The access prefix contains an access prefix sequence, which is also referred to as a signature sequence. Receiving no acknowledge information from the AN within a certain period of time, the terminal retreats for a while, i.e., resends the prefix after waiting for a while.

In Step S402, the AN captures the access prefix sequence sent by the terminal, determines the access sequence is an access prefix sequence sent for preserving the MAC ID, and sends an acknowledge information via an F-CCCH. The acknowledge information contains an access prefix sequence index, a reverse resource allocation information, timing information, and other information.

In Step S403, the terminal receives the acknowledge information, and adjusts the send timing to realize a reverse synchronization with the AN. Further, the terminal scrambles its own UATI by using the preserved MAC ID on a reverse data channel to generate a bind request, and sends the bind request to the AN.

In Step S404, on receiving the bind request, the AN descrambles the received bind request by using all the preserved MAC IDs, and performs detection to obtain the UATI, then generates a bind response after scrambling the detected UATI with the MAC ID that descrambles the bind request, and sends the bind response to the terminal.

In Step S405, the terminal determines whether the bind response is received within a predetermined time period (generally, 100 ms).

If the bind response is not received within a predetermined time period, the access is considered a failure, and the flow goes back to Step S401; otherwise, Step S406 is performed.

In Step S406, the terminal descrambles the received bind response by using the MAC ID, and detects whether the UATI obtained after descrambling is the UATI of its own.

If the UATI obtained after descrambling is the UATI of its own, the access is successful, and the AN sends a service channel allocation message to the terminal via a forward data channel so as to establish a link to the terminal. Otherwise, it indicates that the terminal collides with other users and the access fails, so that a re-access is needed, and the flow goes back to Step S401.

In the method for the user access system provided by the present embodiment, each MAC ID in the Hold set is bound with a sequence in groups at different levels. If an MAC ID is bound with a sequence in each of the nine groups in Table 1, the MAC ID is corresponding to nine sequences. Here, the sequences corresponding to the terminal may only serve the terminal that preserves the MAC ID after the connection with the network is disconnected for accessing, instead of serving other types of terminal accesses. Intending to re-access after the connection with the network is disconnected, the terminal does not need to use the MAC ID for scrambling when sending the access prefix sequence, but directly selects and sends the sequence according to the current level. In this manner, the AN easily determines which terminal is accessing without performing a UATI binding operation, and directly acknowledges and sends timing information. The terminal adjusts the timing according to the received timing information, and completes the access process. This access manner is the fastest but takes up plenty of sequence resources, and thus may only be adopted when the load is light enough. A third embodiment of the present invention will be illustrated in detail below.

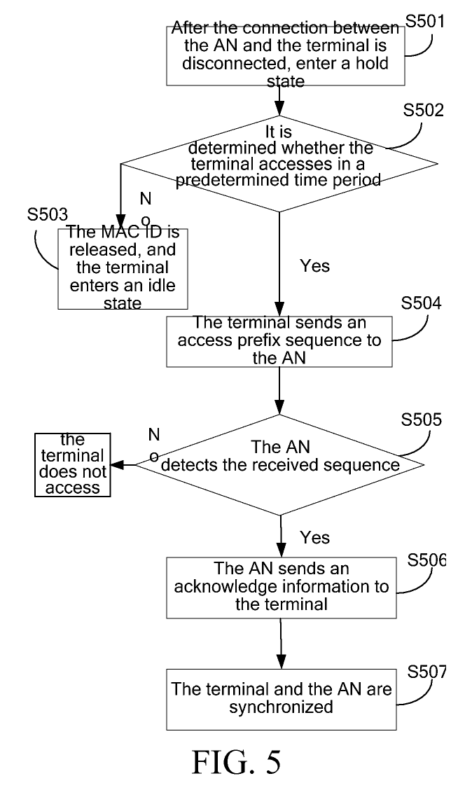

FIG. 5 is a flow chart of a method for a user access system according to this embodiment. The method includes the following steps.

In Step S501, after the connection between the AN and the terminal is disconnected, the AN and the terminal release physical resources other than the MAC ID, and enter a Hold state. Meanwhile, timers on the AN and the terminal start timing, and the MAC ID transits to a Hold set on the AN side.

In Step S502, it is determined whether the terminal initiates an access in a time range set by the timer, and if the terminal does not need to access in a predetermined time period of the timer, Step S503 is performed; otherwise, Step S504 is performed.

In Step S503, the AN and the terminal release the MAC ID simultaneously, and the terminal enters an Idle state.

In Step S504, when accessing again, the terminal first selects an access prefix sequence corresponding to the MAC ID from the access prefix sequence set, and sends the sequence to the AN.

In Step S505, the AN side receives the access prefix sequence, and performs detection to determine whether the terminal accesses. The detection is performed by correlating the access prefix sequences corresponding to all the currently preserved MAC IDs with the received sequence, and if the maximum correlation value exceeds a predetermined threshold, it is determined that the terminal accesses; otherwise, it is determined that the terminal does not access.

In Step S506, after it is determined that the terminal accesses, the AN sends an acknowledge information via an F-CCCH to the terminal. The acknowledge information contains timing information allocated by the AN to the terminal, and other information.

In Step S507, the terminal receives the acknowledge information, and adjusts the send timing to realize a reverse synchronization with the AN.

Thereby, the access is completed.

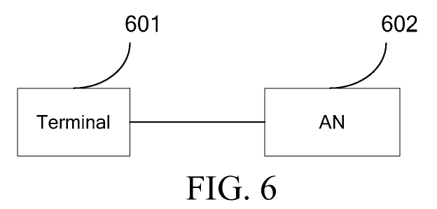

The present embodiment further provides a user access system, which includes a terminal 601 and an AN 602, as shown in FIG. 6.

The terminal 601 is adapted to preserve an MAC ID in a predetermined time period after the connection with the AN 602 is disconnected. If the terminal 601 initiates an access to the AN 602 within the predetermined time period, the MAC ID is used by the terminal 601 for accessing the AN 602.

The AN 602 is adapted to preserve the MAC ID after the connection with the terminal 601 is disconnected.

In the system of the present embodiment, after selecting an access prefix sequence, the terminal 601 scrambles the access prefix sequence and sends the scrambled sequence to the AN 602.

In the system of the present embodiment, on receiving the scrambled sequence, the AN 602 descrambles the sequence, and performs detection to determine whether the terminal 601 accesses.

In the system of the present embodiment, the terminal 601 is adapted to randomly select an access prefix sequence from all access prefix sequences, or randomly select an access prefix sequence from multiple access prefix sequences in each group, or select an access prefix sequence from access prefix sequences in each group corresponding to the MAC ID.

In the system of the present embodiment, the terminal 601 is adapted to scramble the access prefix sequence with the MAC ID or a scrambling code corresponding to the MAC ID.

In the system of the present embodiment, the AN 602 is adapted to descramble the scrambled sequence with all the preserved MAC IDs or scrambling codes corresponding to all the MAC IDs after receiving the scrambled sequence.

The AN 602 is adapted to correlate the descrambled sequence with all the access prefix sequences or access prefix sequences in each group corresponding to the MAC ID. If a maximum correlation value exceeds a predetermined threshold, it is determined that the terminal 601 preserving the MAC ID accesses.

After the AN 602 performs correlation by using the access prefix sequences corresponding to the MAC ID, and determines the sequence corresponding to the location of a maximum value is an access prefix sequence corresponding to the MAC ID whether the maximum value among the correlation values exceeds a predetermined threshold, the AN 602 determines that the terminal 601 preserving the MAC ID accesses.

In the system of the present embodiment, after establishing a connection with the AN via the access prefix sequence, the terminal 601 scrambles its own UATI with the preserved MAC ID to generate a bind request and sends the bind request to the AN 602, then determines the UATI restored from the descrambling of the bind response by the AN 602, and if the obtained UATI is the UATI of its own, determines that the access is successful.

The AN 602 is adapted to descramble the bind request received from the terminal 601 to restore the MAC ID and UATI, scrambles the UATI with the MAC ID to generate a bind response, and sends the bind response to the terminal 601.

The terminal 601 is adapted to send to the AN 602 a designated access prefix sequence from access prefix sequences in each group corresponding to the MAC ID.

The AN 602 is adapted to receive the sequence from the terminal 601 and detect whether the terminal 601 accesses.

The AN 602 is adapted to correlate the received sequence with the access prefix sequences in each group corresponding to the MAC ID, determine whether a maximum value among the correlation values exceeds a predetermined threshold, and if yes, determine the terminal 601 that preserves the MAC ID accesses.

In an embodiment of the present invention, a user access system includes a terminal and an AN.

The terminal is adapted to preserve an MAC ID in a predetermined time period after the connection with the AN is disconnected. If the terminal initiates an access to the AN within the predetermined time period, the MAC ID is used by the terminal for accessing the AN.

The AN is adapted to preserve the MAC ID after the terminal is disconnected.

After selecting an access prefix sequence, the terminal scrambles the access prefix sequence and sends the sequence to the AN

On receiving the scrambled sequence, the AN descrambles the scrambled sequence, and performs detection to determine whether the access is a terminal access corresponding to the MAC ID.

The terminal includes a selection unit and a scrambling unit.

The selection unit is adapted to select an access prefix sequence from all access prefix sequences, or select an access prefix sequence from access prefix sequences in each group corresponding to the MAC ID.

The scrambling unit is adapted to scramble the access prefix sequence with the MAC ID or a scrambling code corresponding to the MAC ID.

The AN includes a descrambling unit, a first sequence processing unit, a determination unit, and a second sequence processing unit.

The descrambling unit is adapted to descramble the scrambled sequence with all the preserved MAC IDs or scrambling codes corresponding to all the MAC IDs after receiving the scrambled sequence.

The first sequence processing unit is adapted to correlate the descrambled sequence with all the access prefix sequences or access prefix sequences in each group corresponding to the MAC ID.

The determination unit is adapted to determine the access terminal according to the correlation value.

If it is determined that a maximum value among the correlation values exceeds a predetermined threshold, the access terminal is a terminal corresponding to the preserved MAC ID.

The second sequence processing unit is adapted to correlate the received sequence with the access prefix sequence corresponding to the MAC ID. If a maximum value among the correlation values exceeds a predetermined threshold, the second sequence processing unit determines whether the sequence corresponding to the location of the maximum value is an access prefix sequence corresponding to the MAC ID, and if yes, determines the access terminal as a terminal corresponding to the MAC ID.

As described above, in the technical solutions provided by the present embodiment, after the connection between a terminal and an AN is disconnected, a MAC ID is preserved in a predetermined time period. If the terminal initiates an access to the AN within the predetermined time period, the MAC ID is used by the terminal for accessing the AN. As it is unnecessary to wait for the AN to re-allocate the MAC ID, the time for the terminal to re-initiate an access is reduced. Further, the terminal already has an MAC ID before the initiation of an access, so the access collision is avoided and the system performance is greatly enhanced.

It will be apparent to those skilled in the art that various modifications and variations can be made to the present invention without departing from the scope or spirit of the invention. In view of the foregoing, it is intended that the present invention cover modifications and variations of this invention provided that they fall within the scope of the following claims and their equivalents.

What is claimed is:

1. A user access method, comprising:
preserving a media access control identifier MAC ID in a predetermined time period after the connection between a terminal and an access network AN is disconnected; and
adopting, by the terminal, the MAC ID for accessing the AN, if the terminal initiates an access to the AN within the predetermined time period.

2. The method according to claim 1, wherein the accessing, by the terminal, to the AN comprises:
selecting, by the terminal, an access prefix sequence, scrambling the access prefix sequence and sending the scrambled access prefix sequence to the AN, and descrambling and detecting, by the AN, the scrambled access prefix sequence on receiving the scrambled access prefix sequence, so as to determine whether the access is a terminal access corresponding to the MAC ID.

3. The method according to claim 2, wherein the selecting, by the terminal, the access prefix sequence comprises:
selecting, by the terminal, an access prefix sequence from all access prefix sequences, or selecting an access prefix sequence from access prefix sequences in each group corresponding to the MAC ID.

4. The method according to claim 2, wherein
the scrambling is: scrambling, by the terminal, the access prefix sequence with the MAC ID or a scrambling code corresponding to the MAC ID; and
the descrambling is: after receiving the scrambled access prefix sequence, descrambling, by the AN, the scrambled access prefix sequence with all the preserved MAC IDs or scrambling codes corresponding to all the MAC IDs.

5. The method according to claim 2, wherein the detecting, by the AN, comprises:
correlating the descrambled access prefix sequence with all the access prefix sequences or the access prefix sequences in each group corresponding to the MAC ID, determining whether a maximum value among correlation values exceeds a predetermined threshold, and if yes, determining the terminal as a terminal corresponding to the MAC ID.

6. The method according to claim 5, wherein the detection further comprises:
determining whether the access prefix sequence corresponding to the location of the maximum value is an access prefix sequence corresponding to the MAC ID, and if yes, determining the terminal as a terminal corresponding to the MAC ID.

7. The method according to claim 1, wherein the accessing to the AN comprises:
scrambling, by the terminal, its own unicast access terminal identifier UATI with the preserved MAC ID to generate a bind request after establishing a connection with the AN via the access prefix sequence, and sending the bind request to the AN;
descrambling, by the AN, the received bind request to restore the MAC ID and UATI, scrambling the UATI with the MAC ID to generate a bind response, and sending the bind response to the terminal; and
descrambling, by the terminal, the received bind response to restore the UATI, determining whether the obtained UATI is the UATI of its own, and if yes, determining that the accessing is successful.

8. The method according to claim 1, wherein the accessing, by the terminal, to the AN comprises:
sending, by the terminal, to the AN a designated access prefix sequence from access prefix sequences in each group corresponding to the MAC ID; and
receiving, by the AN, the access prefix sequence, and performing detection to determine whether the access is a terminal access corresponding to the MAC ID.

9. The method according to claim 8, wherein the detection comprises:
correlating the received access prefix sequence with the access prefix sequences in each group corresponding to the MAC ID, determining whether a maximum value among correlation values exceeds a predetermined threshold, and if yes, determining the terminal as a terminal corresponding to the MAC ID.

10. A user access system, comprising a terminal and an access network AN, wherein
the terminal is adapted to preserve a media access control identifier MAC ID in a predetermined time period after the connection with the AN is disconnected, and if the terminal initiates an access to the AN within the predetermined time period, the MAC ID is used by the terminal for accessing the AN; and
the AN is adapted to preserve the MAC ID after the terminal is disconnected.

11. The system according to claim 10, wherein
after selecting an access prefix sequence, the terminal scrambles the access prefix sequence and sends the scrambled access prefix sequence to the AN; and
on receiving the scrambled access prefix sequence, the AN descrambles and detects the scrambled access prefix sequence to determine whether the access is a terminal access corresponding to the MAC ID.

12. The system according to claim 11, wherein the terminal comprises:
a selection unit, adapted to select an access prefix sequence from all access prefix sequences, or select an access prefix sequence from access prefix sequences in each group corresponding to the MAC ID.

13. The system according to claim 11, wherein
the terminal comprises: a scrambling unit, adapted to scramble the access prefix sequence with the MAC ID or a scrambling code corresponding to the MAC ID; and
the AN comprises: a descrambling unit, adapted to descramble the scrambled access prefix sequence with all the preserved MAC IDs or scrambling codes corresponding to all the MAC IDs after receiving the scrambled access prefix sequence.

14. The system according to claim 12, wherein the AN further comprises:
a first sequence processing unit, adapted to correlate the descrambled access prefix sequence with all the access prefix sequences or access prefix sequences in each group corresponding to the MAC ID;
a determination unit, adapted to determine the terminal according to correlation values; and
if it is determined that a maximum value among the correlation values exceeds a predetermined threshold, determine the terminal as a terminal corresponding to the preserved MAC ID.

15. The system according to claim 14, wherein the AN further comprises:
a second sequence processing unit, adapted to correlate the received sequence with the access prefix sequence corresponding to the MAC ID, if a maximum value among the correlation values exceeds a predetermined threshold, determine whether the access prefix sequence corresponding to the location of the maximum value is an access prefix sequence corresponding to the MAC ID, and if yes, determine the terminal as a terminal corresponding to the MAC ID.

16. The system according to claim 10, wherein
after establishing a connection with the AN via the access prefix sequence, the terminal scrambles its own unicast access terminal identifier UATI with the preserved MAC ID to generate a bind request and sends the bind request to the AN, then determines the UATI restored from the descrambling of the bind response by the AN, and if the obtained UATI is the UATI of its own, determines that the accessing is successful; and
the AN descrambles the bind request received from the terminal to restore the MAC ID and UATI, scrambles the UATI with the MAC ID to generate a bind response, and sends the bind response to the terminal.

17. The system according to claim 10, wherein
the terminal is adapted to send to the AN a designated access prefix sequence from access prefix sequences in each group corresponding to the MAC ID; and
the AN is adapted to receive the access prefix sequence from the terminal and detect whether the access is a terminal access corresponding to the MAC ID.

18. The method according to claim 17, wherein
the AN is adapted to correlate the received access prefix sequence with the access prefix sequences in each group corresponding to the MAC ID, determine whether a maximum value among correlation values exceeds a predetermined threshold, and if yes, determine the access as a terminal access corresponding to the MAC ID.

19. A terminal, wherein
the terminal is adapted to preserve a media access control identifier MAC ID in a predetermined time period after the connection with an access network AN is disconnected, and if the terminal initiates an access to the AN within the predetermined time period, the MAC ID is used by the terminal for accessing the AN.

20. The terminal according to claim 19, wherein the terminal comprises:
a selection unit, adapted to select an access prefix sequence from all access prefix sequences, or select an access prefix sequence from access prefix sequences in each group corresponding to the MAC ID.
